(19) United States
(12) Patent Application Publication
(10) Pub. No.: US 2013/0215640 A1
(43) Pub. Date: Aug. 22, 2013

(54) LIGHT GUIDE PLATE AND METHOD OF MANUFACTURING SAME

(71) Applicant: LI-YING HE, Tu-Cheng (TW)

(72) Inventor: LI-YING HE, Tu-Cheng (TW)

(73) Assignee: HON HAI PRECISION INDUSTRY CO., LTD., Tu-Cheng (TW)

(21) Appl. No.: 13/467,058

(22) Filed: May 9, 2012

(30) Foreign Application Priority Data
Feb. 21, 2012 (TW) 101105706

(51) Int. Cl. F21V 8/00; G02B 6/10

(52) U.S. Cl. 362/606; 362/625; 264/1.24

(57) ABSTRACT

An exemplary light guide plate includes a top light emitting surface, a bottom surface, and a light incident surface. The light incident surface is between the light emitting surface and the bottom surface. The bottom surface defines a plurality of hemispherical micro grooves arranged in an array, a maximum depth of each micro groove along a direction perpendicular to the bottom surface is H, each micro groove has a circular opening, a diameter of the opening is D, and D:H=10:1.

### BACKGROUND

1. Technical Field

The present disclosure relates to a light guide plate and a method for manufacturing the light guide plate.

2. Description of Related Art

A typical light guide plate has a light emitting surface and a bottom surface at opposite sides thereof. The bottom surface forms a number of micro protrusions. However, the light brightness value of the light guide plate is somewhat low. In addition, the light brightness value of the light guide plate cannot be improved a lot even if the arrangement of the micro protrusions is changed.

Therefore, it is desirable to provide a light guide plate and a manufacturing method that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views, and both the views are schematic.

FIG. 1 is an isometric, cutaway view of a light guide plate according to an exemplary embodiment, showing the light guide plate inverted, and showing the light guide plate together with a row of light sources.

FIG. 2 is a diagram showing successive stages of a method of manufacturing the light guide plate of FIG. 1, according to an exemplary embodiment.

### DETAILED DESCRIPTION

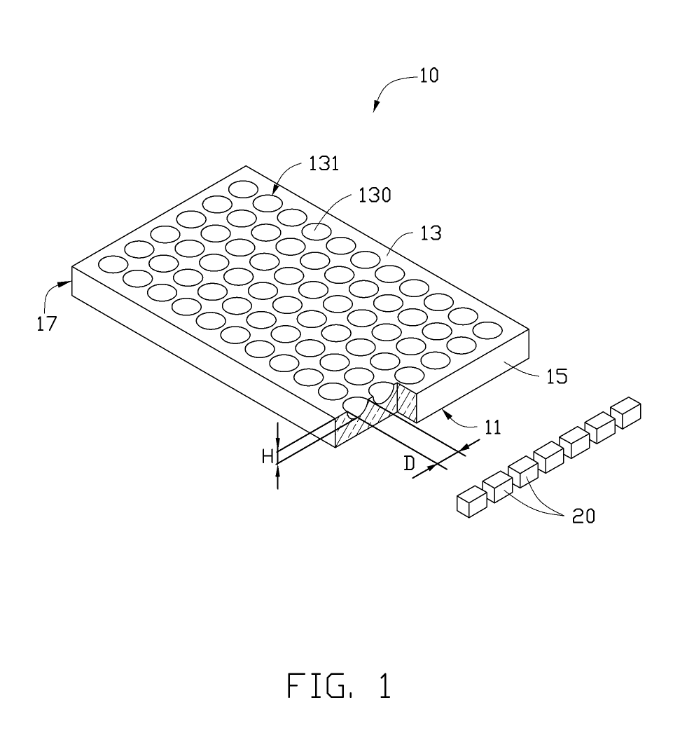

FIG. 1 shows a light guide plate 10 according to an exemplary embodiment. The light guide plate 10 is made of a transparent material (such as acrylic resin or polyethylene resin), and includes a top light emitting surface 11, a bottom surface 13, a light incident surface 15, and a side surface 17. The bottom surface 13 is substantially parallel to the light emitting surface 11. The light incident surface 15 is connected to the light emitting surface 11 and the bottom surface 13. The light incident surface 15 is substantially perpendicular to the light emitting surface 11. The side surface 17 is connected to the light emitting surface 11 and the bottom surface 13, and is at an opposite side of the light guide plate 10 to the light incident surface 15. In other embodiments, the bottom surface 13 can be inclined with respect to the light emitting surface 11.

In a typical application of the light guide plate 10, the light incident surface 15 transmits light rays from external light sources 20 into the light guide plate 10. The bottom surface 13 and the side surface 17 respectively internally reflect the light rays in the light guide plate 10. The light emitting surface 11 transmits a portion of the light rays incident thereon to the exterior above the light guide plate 10, and reflects the other portion of the light rays incident thereon back into the light guide plate 10.

The bottom surface 13 defines a number of hemispherical micro grooves 130 arranged in a regular m×n array (matrix). All the micro grooves 130 are the same. A maximum depth of each micro groove 130 along a direction perpendicular to the bottom surface 13 is H. Each micro groove 130 has a circular opening 131. A diameter of the opening 131 is D, wherein D:H=10:1. In this embodiment, D is about 50 μm (micrometers), and H is about 5 μm.

The light guide plate 10 is divided into, for example, 20 equal areas, and 13 areas of the 20 areas are selected, for example, for the purposes of measuring brightness of the light guide plate 10. An average light brightness value of the light guide plate 10 is deemed to be an average of light brightness values of the selected 13 areas.

Table 1 below shows the light brightness values of the 13 selected areas, and the average light brightness value, of the light guide plate 10 of this embodiment. Nit is a unit of luminance equivalent to one candela per square meter (1 cd/m²).

TABLE 1

| | Area | | | | |
|---|---|---|---|---|---|
| | 1 | 2 | 3 | 4 | 5 |
| Light brightness value | 3243.99 | 3312.85 | 3264.64 | 3563.71 | 3601.11 |
| (Nit) | | | | | |
| | Area | | | | |
| | 6 | 7 | 8 | 9 | 10 |
| Light brightness value | 3341.21 | 3817.85 | 3304.39 | 3644.97 | 3697.85 |
| (Nit) | | | | | |

| | | | | Average light |
|---|---|---|---|---|
| | Area | | | brightness value |
| | 11 | 12 | 13 | (Nit) |
| Light brightness value | 3177.74 | 3622.87 | 3173.21 | 3443.57 |
| (Nit) | | | | |

A light guide plate of related art is divided into 20 equal areas, and 13 areas of the 20 areas are selected for the purposes of measuring brightness of the light guide plate. That is, the areal division and selection of the related art light guide plate are substantially the same as the areal division and selection of the light guide plate 10.

Table 2 below shows the light brightness values of the 13 selected areas, and an average light brightness value, of the light guide plate of related art.

TABLE 2

| | Area | | | | |
|---|---|---|---|---|---|
| | 1 | 2 | 3 | 4 | 5 |
| Light brightness value | 2911.19 | 2990.00 | 2949.10 | 3255.65 | 3281.80 |
| (Nit) | | | | | |
| | Area | | | | |
| | 6 | 7 | 8 | 9 | 10 |
| Light brightness value | 2982.63 | 3423.27 | 2910.14 | 3350.53 | 3264.19 |
| (Nit) | | | | | |

| | | | | Average light |
|---|---|---|---|---|
| | Area | | | brightness |
| | 11 | 12 | 13 | value (Nit) |
| Light brightness value | 2847.53 | 3206.61 | 2825.81 | 3092.19 |
| (Nit) | | | | |

Comparing Table 1 with Table 2, the light brightness values of the 13 selected areas and the average light brightness value of the light guide plate 10 of this embodiment are respectively larger than those of the light guide plate of related art. Therefore, the light brightness value of the light emitting surface 11 is greatly improved over the related art.

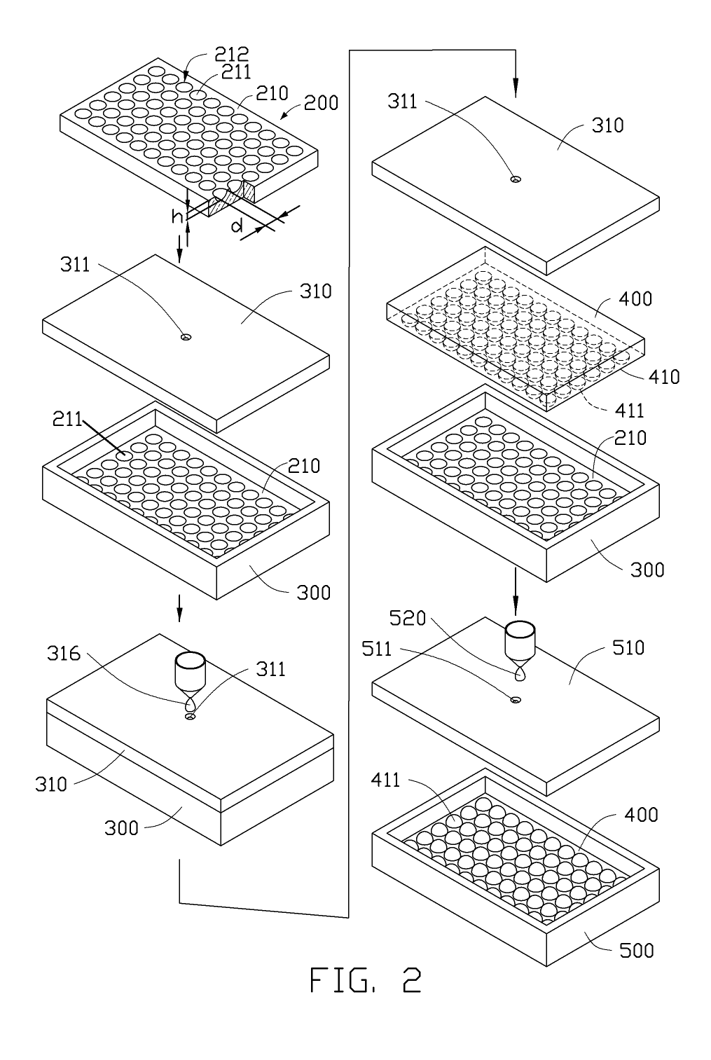

FIG. 2 shows successive stages of a method of manufacturing the light guide plate 10 according to an exemplary embodiment. The method includes the following steps.

Step 1: a first molding core 200 is provided. The first molding core 200 is made of plaster, and has a flat first molding surface 210. A number of hemispherical molding grooves 211 arranged in a regular m×n array are defined in the first molding surface 210 using a laser machine. A maximum depth of each molding groove 211 perpendicular to the first molding surface 210 is h. Each molding groove 211 has a circular molding opening 212. A diameter of the molding opening 212 is d, wherein d:h=10:1.

Step 2: a tank 300 is provided. The tank 300 has a first cover 310, and the first cover 310 has a first through hole 311 defined therein. The first molding core 200 is received in the tank 300, and the first cover 310 is attached on the tank 300 with the molding grooves 211 facing the first through hole 311. In this embodiment, the tank 300 is cuboid. In other embodiments, the tank 300 can have other shapes, such as a cylinder shape.

Step 3: molten metal 316 is injected into the tank 300 through the first through hole 311.

Step 4: the molten metal 316 is cooled to become solid, and a second molding core 400 is thus obtained. The second molding core 400 has a second molding surface 410 corresponding to the first molding surface 210, and the second molding surface 410 includes a number of hemispherical micro protrusions 411 arranged in the regular m×n array.

Step 5: the second molding core 400 is mounted into a mold injection machine 500, with the micro protrusions 411 facing up. The mold injection machine 500 has a second cover 510, and the second cover 510 has a second through hole 511 defined therein. The second cover 510 is attached on the mold injection machine 500. Molten material 520 for the light guide plate 10 is injected into the mold injection machine 500 through the second through hole 511 to obtain the light guide plate 10.

In the typical application of the light guide plate 10, when the light rays transmitted in the light guide plate 10 arrive at the micro grooves 130, the light rays can be reflected by the surfaces of the micro grooves 130 directly to the light emitting surface 11. Thus the transmitting paths of the light rays in the light guide plate 10 are shorter, and the energy loss of the light rays is reduced. Accordingly, the light brightness value of the light emitting surface 11 is greatly improved.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A light guide plate comprising:
a top light emitting surface;
a bottom surface; and
a light incident surface between the light emitting surface and the bottom surface;
wherein the bottom surface defines a plurality of hemispherical micro grooves arranged in an array, a maximum depth of each micro groove along a direction perpendicular to the bottom surface is H, each micro groove has a circular opening, a diameter of the opening is D, and D:H=10:1.

2. The light guide plate of claim 1, further comprising a side surface connected to the light emitting surface and the bottom surface, wherein the side surface is at an opposite side of the light guide plate to the light incident surface, and is provided for internally reflecting light rays in the light guide plate.

3. The light guide plate of claim 1, wherein the light incident surface is substantially perpendicular to the light emitting surface.

4. The light guide plate of claim 1, wherein the bottom surface is inclined with respect to the light emitting surface.

5. A light guide plate comprising:
a light incident surface for transmitting light rays from at least one external light source into the light guide plate;
a bottom surface for internally reflecting light rays in the light guide plate; and
a top light emitting surface for transmitting a portion of light rays in the light guide plate incident thereon to the exterior above the light guide plate, and reflecting the other portion of the light rays incident thereon back into the light guide plate;
wherein the bottom surface defines a plurality of hemispherical micro grooves arranged in an array, a maximum depth of each micro groove along a direction perpendicular to the bottom surface is H, each micro groove has a circular opening, a diameter of the opening is D, and D:H=10:1.

6. The light guide plate of claim 5, further comprising a side surface connected to the light emitting surface and the bottom surface, the side surface is at an opposite side of the light guide plate to the light incident surface, and is configured for internally reflecting the light rays in the light guide plate.

7. The light guide plate of claim 5, wherein the light incident surface is perpendicular to the light emitting surface.

8. The light guide plate of claim 5, wherein the bottom surface is inclined with respect to the light emitting surface.

9. A method of manufacturing a light guide plate, the method comprising:
providing a first molding core made of plaster, wherein the first molding core has a flat first molding surface defining a plurality of hemispherical molding grooves arranged in an array, each molding groove has a molding opening, and a ratio of the diameter of each molding opening to a maximum depth of each first molding groove is 10:1;
providing a tank, and placing the first molding core in the tank;
injecting molten metal into the tank;
cooling the molten metal to form a second molding core, wherein the second molding core has a second molding surface forming a plurality of hemispherical micro protrusions arranged in an array; and
mounting the second molding core into a mold injection machine, and injecting molten material into the mold injection machine to obtain a light guide plate.

10. The method of claim 9, wherein the tank has a cover defining a through hole, the molding grooves face the through hole, and the molten metal is injected into the tank through the through hole.

11. The method of claim 9, wherein the mold injection machine has a cover defining a through hole, the micro protrusions face the through hole, and the molten material is injected into the mold injection machine through the through hole.

12. The method of claim 9, further comprising, prior to providing the first molding core made of plaster, defining the molding grooves in the first molding surface of the first molding core using a laser.

13. The method of claim 9, wherein the hemispherical micro protrusions of the second molding core correspond to the hemispherical molding grooves of the first molding core.

14. The method of claim 13, wherein a bottom surface of the obtained light guide plate defines a plurality of hemispherical micro grooves arranged in an array, and the hemispherical micro grooves correspond to the hemispherical micro protrusions of the second molding core.
